(19) United States
(12) Patent Application Publication
(10) Pub. No.: US 2026/0179794 A1
(43) Pub. Date: Jun. 25, 2026

(54) IN-SITU EVAPORATIVE REMOVAL OF LIQUID METAL COOLANT FROM NUCLEAR REACTOR FUEL RODS AND COMPONENTS

(71) Applicant: Aalo Holdings, Inc., dba Aalo Atomics, Austin, TX (US)

(72) Inventors: Yasir Arafat, Austin, TX (US); Jeffrey Donald Jones, Idaho Falls, ID (US); Kade Michael Fish, Idaho Falls, ID (US); Jared Lee Fraisure, Austin, TX (US); Richard Charles Williams, Idaho Falls, ID (US); Matthew John Hansink, Rigby, ID (US)

(21) Appl. No.: 19/435,184

(22) Filed: Dec. 29, 2025

Related U.S. Application Data
(60) Provisional application No. 63/738,629, filed on Dec. 24, 2024.

(51) Int. Cl. G21C 19/20

(52) U.S. Cl. CPC G21C 19/207

(57) ABSTRACT

An apparatus comprising a main vessel containing the component and coolant, a coolant movement/displacement mechanism, a heating mechanism for coolant evaporation, a transport pathway for coolant vapors, a vacuum means or gas circulation means, a cooling and collection mechanism for condensation of coolant vapors and a collection vessel for storage of moved/displaced fluid.

### CROSS-REFERENCE TO RELATED APPLICATION AND PRIORITY CLAIM

This application claims priority under 35 U.S.C. § 119 (e) to U.S. Provisional Patent Application No. 63/738,629 filed on Dec. 24, 2024, which is hereby incorporated by reference in its entirety.

### TECHNICAL FIELD

The present disclosure is within the field of nuclear power generating systems and methods, and in particular for systems and methods for refueling and maintaining nuclear reactors.

### BACKGROUND

In the art of nuclear power generation, liquid metal coolants (LMCs), such as sodium, NaK or sodium-potassium alloy, lead, lead-bismuth, etc., have advantageous differences in their properties from those of alternative coolants (such as water or helium) that provide significant advantages. Two such differences, higher thermal conductivity and lower operating pressure, produce the corresponding advantages of allowing higher power density and thinner reactor vessel walls, respectively, both of which can be advantageous regarding cost, performance, and size. One disadvantageous property, however, is that liquid metals, when exposed to air, chemically react with moisture and oxygen, create fumes and smoke, and/or may evolve flammable hydrogen gases, or combinations thereof. Different reactors use different coolants, and their overall effectiveness in meeting cost and performance objectives are, in part, a function of the trade-offs between these advantages and disadvantages. The present invention reduces cost, operational, and safety impacts of these disadvantageous properties of liquid metal coolants, allowing their advantages to be more effectively exploited.

One undesirable disadvantage of using liquid metal coolants in the current art is the resultant complication of handling and maintenance activities inside the reactor. Sometime during operation, the necessity of moving, repositioning, removing, and/or replacing nuclear fuel that occupied the reactor core during operation arises. Additionally, the necessity may arise to conduct maintenance on components within the reactor vessel. Both necessities are undesirably complicated by the aforementioned disadvantages of liquid metal coolants being exposed to air.

In addition to decreasing and/or mitigating the consequences of undesirable chemical reactions of the liquid metal coolant, the phenomenon of decay heat must be dealt with. The reactor is shut down prior to performing fuel movement or component maintenance activities; while shutdown, the nuclear chain reaction ceases yet heat from the continued decay of the nuclear fission and activation products continues. The decay heat curve has an amplitude and drop-off steepness that varies with fuel composition, reactor core configuration, and reactor operation, affecting how long cooling of the fuel needs to be maintained in any given case, as well as limiting how soon fuel movement and maintenance activities can be performed and how long the components are kept in contact with the liquid metal coolant. There can be several intermediate steps of cooling of fuel rods and assemblies between initial shutdown and final storage. For example, in the Fast Flux Test Facility reactor, before being able to place the assemblies in final dry storage, 4 years of decay with fuel assemblies submerged in liquid sodium was required for the fuel assemblies to meet the combined limits of less than 250 watts of decay heat per assembly and cladding temperature of less than 900° F. Even then, before transferring the assemblies to dry storage, they were carefully washed, and this required an additional 24 hours for each assembly because of the specialized equipment used and required handling precautions.

In a first mitigating approach in the current art, the activities of moving fuel from, within, or to the core, and/or maintenance activities within the reactor vessel, are conducted in a self-contained manner, i.e., where the handling or maintenance activity is conducted entirely within the sealed enclosure of the reactor vessel. This “internally contained” approach substantially reduces the unintended exposure of the liquid metal coolant to air, however it undesirably complicates the equipment design. With this approach, internally contained handling/maintenance equipment must withstand challenging operating conditions within the reactor vessel (which include elevated operating temperature, opacity of the coolant that prevents visual feedback of positioning and fuel/component conditions, and limited materials selection to avoid potential chemical reaction of the coolant). Additionally, it requires equipment capable of and the step of heating the fuel up to temperature so as to match thermal expansion of the mating components/neighboring fuel. Also additionally, it must comprise some mechanical, pneumatic, or electronic/electrical connection(s) to/from the control system or controlling operator. Such a connection is difficult to maintain between the interior and exterior environments, and it invariably involves use of a seal, pass-through, or linkage that is at risk of degrading and creating an unwanted leakage pathway between the air and the sealed reactor internal space. Additionally, the “internally contained” approach necessitates a larger reactor vessel to accommodate the required ancillary devices. Accordingly, this will significantly limit possible reductions in overall reactor assembly dimensions as is highly desirable for achieving the smallest possible reactor footprints for any given power generation capacity, such as for “microreactors”, the deployment of which may be a key solution to today's mounting and potentially crippling power grid demands if only from the burgeoning data center sector.

In the above-mentioned first mitigating approach of internally contained movement/maintenance activity, the current art may further use in-situ transfer to move fuel to an internal storage basket that is immersed in liquid metal coolant and where decay is allowed to occur (i.e., within the primary coolant boundary of the reactor vessel) without being removed from the vessel. This within-vessel temporary storage of the fuel frees up space in the core and allows it to be utilized independently while the decay heat drops off. One such in-situ cooling basket was used in the Experimental Breed Reactor-II sodium-cooled reactor when operational, wherein fuel assemblies were placed for about 100 days prior to being removed from the reactor vessel. This provided fuel cooling prior to removal but also added the additional handling steps of transfer to basket and removal from basket. Additional handling steps increase the downtime of a power-generating reactor which is disadvantageous from availability and cost standpoints. Additionally, a basket requiring additional capacity in the reactor vessel volume is likewise disadvantageous from a reactor vessel cost and size standpoint, the latter particularly being the case for microreactors.

In a second mitigating approach of the current art, fuel and/or components are removed from a reactor vessel while they are still wetted with liquid metal coolant (e.g., during refueling). The second mitigating approach involves at least an apparatus and method of mating a special transfer cask in a sealed manner to the reactor vessel, opening a valve or port between the cask and reactor vessel, withdrawing the LMC-wetted fuel/component to the transfer cask, and reclosing the valve or port. Once within the transfer cask, the fuel or component is still wetted with LMC and must still be handled. Difficulties of LMCs in this cask are like those mentioned with LMCs in the reactor vessel. It is difficult to achieve or maintain a perfectly inert environment during the transfer; reactions of the liquid metal with traces of oxygen and water vapor cause formation and buildup of undesirable solid reaction products and deposits, and possibly evolution of flammable gases (e.g., hydrogen) during continued occupation of and use of the cask. In one variation of this second mitigating approach, a wash liquid might be introduced into the cask and by spray or immersion and dissolve the LMC. This can remove the hazards and difficulties of the LMC but adds safety concerns (as reactions with the wash liquid can be quite exothermic) and a waste stream that now must be handled.

In summary, the current art uses one or both mitigation approaches as described, and potentially sequential iterations thereof, all with undesirable disadvantages. The present disclosure is of an apparatus and method that addresses these disadvantages by substantially eliminating the presence of the LMC from the reactor vessel and allowing the vessel to be opened to air to perform fuel handling and/or maintenance within a far more forgiving, less stringent, and less reactive environment, while eliminating the equipment, space-related, and added operational complexity-related disadvantages the above-described conventional methods and systems for reactor fuel replacement or maintenance operations. This LMC removal comprises evaporation of LMC from liquid to vapor form and optionally includes pre-removal of some of the LMC while still in liquid form.

### SUMMARY

The present invention, as disclosed and described herein, in one aspect thereof comprises an apparatus and method comprising a main vessel containing the component and coolant, a coolant movement/displacement mechanism, a heating mechanism for coolant evaporation, a transport pathway for coolant vapors, a vacuum means or gas circulation means, a cooling and collection mechanism for condensation of coolant vapors and a collection vessel for storage of moved/displaced fluid.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a primary vessel and sodium evaporation/condensation system;

FIG. 2 illustrates an apparatus and valve configuration for a first exemplary process: liquid draining;

FIG. 3 illustrates an apparatus and valve configuration for a second exemplary process: convective drying;

FIG. 4 illustrates an apparatus and valve configuration for a third exemplary process: vacuum distillation;

FIG. 5 illustrates an alternative embodiment of a fuel/component storage vessel;

FIG. 6 illustrates an apparatus and valve configuration for a fifth exemplary process: liquid refilling; and

FIG. 7 illustrates a vapor-liquid equilibrium curve for liquid and gaseous sodium.

### DETAILED DESCRIPTION

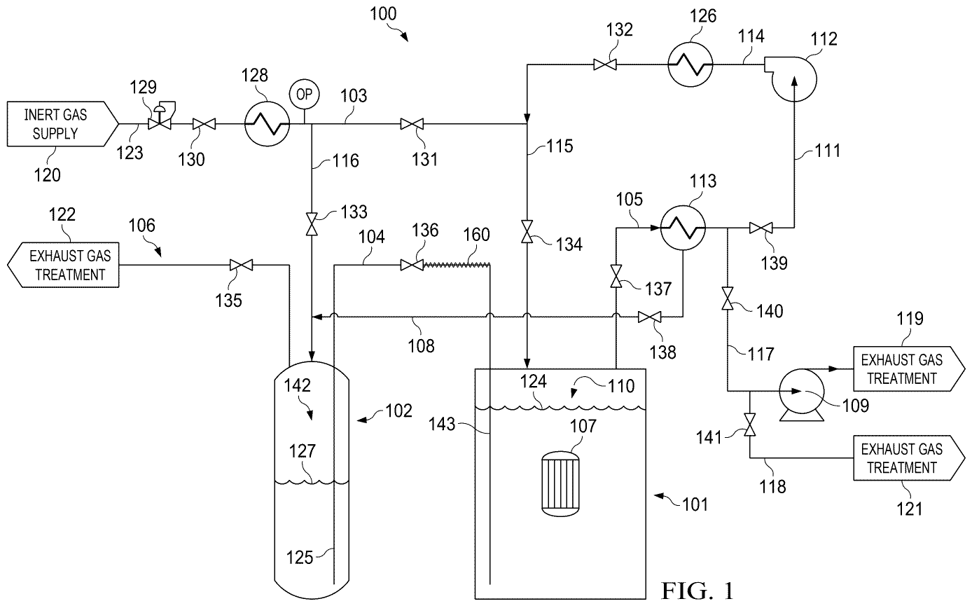

In a first embodiment, an evaporation and condensation system 100 is represented by the schematic diagram in FIG. 1. The relative arrangements of the elements are applicable to this particular embodiment and its alternatives described herein, but the relative distances between elements (e.g., between valves and vessels and/or between valves and vacuum pump/blower) in the schematic are not necessarily representative of distances in the present invention.

A primary vessel 101 of an exemplary embodiment of the present system holds a volume of liquid metal coolant depicted with fluid surface 124 at an arbitrary elevation and includes conduits for vapor and/or gas 103, 105, 106, 111, 114-118, and 123; conduits for liquid 104 and 108; inert gas supply 120 (the inert gas being preferably argon and less preferably nitrogen, as examples) and pressure regulator 129; condensate collection vessel 102; and exhaust gas outlet 122. The apparatus further comprises a reactor core 107; condenser 113 and at least one of means 112 for gas circulation (e.g., a blower) positioned downstream of condenser 113 and/or a vacuum pump 109 in fluid communication with condenser 113 and exhaust outlet 119; at least one component typical to a nuclear reactor primary vessel (e.g., control rod, primary pump, primary heat exchanger-not shown); and at least one nuclear fuel rod (not shown). Pressure gauge OP can be used in the location presented and/or additional such gauges may be located in various other locations to provide pressure measurements as appropriate for operating, safety and monitoring as is common in the art. To prevent coolant from freezing or condensing in regions that may be damaging to the apparatus and/or that may degrade outcomes of the processes, all piping, tubing, vessels, valves and instruments of system 100 are provided with external heating means with insulation 160. Although only a short section of fluid conduit 104 in FIG. 1 is depicted with external heating means 160, it should be well understood by those skilled in the art that even while not shown elsewhere, heating means 160 should extend and cover all piping, tubing, vessels, valves, heat exchangers, pump and blower heads, etc. in all embodiments and exemplary processes in this disclosure, except as may be noted. External heating means 160 are preferred to be mineral insulated heat trace, but may include fiberglass insulated heat trace, ceramic band heaters, cal-rod heaters, or the like. These heating means 160 ensure for proper liquid-phase and vapor-phase transport and condensation of the coolant during the apparatus operation. System 100 can be installed and operated within, for example, a nuclear power plant.

The elements in system 100 that contact liquid metal coolant are constructed of a material compatible with the reactive liquid metal coolant. In an embodiment where the LMC is liquid sodium or NaK, for example, the compatible materials include stainless steel or nickel alloys, preferably type 316 stainless steel. Vessels 101 and 102 are designed to withstand both negative and positive pressures along with the elevated temperatures in accordance with standards within the art. The required pressures tolerance parameters will be readily apparent to persons of skill in the relevant art. The first embodiment presented in FIG. 1 utilizes the reactor vessel as the primary vessel 101 but alternative embodiments will be shown hereafter.

In the embodiment shown in FIG. 1, the heating means for coolant evaporation is the decay heat from nuclear fuel in the reactor core 107. Alternative and/or supplementary means of heating (not shown) may include gas under forced convection, resistive heaters, heated heat transfer fluids or gas pumped through a shell around primary vessel 101, or electric band heaters in contact with the outer wall of primary vessel 101.

In accordance with the present disclosure, five exemplary processes can be used in various embodiments and sequences in the removal of LMC for nuclear reactor refueling or maintenance.

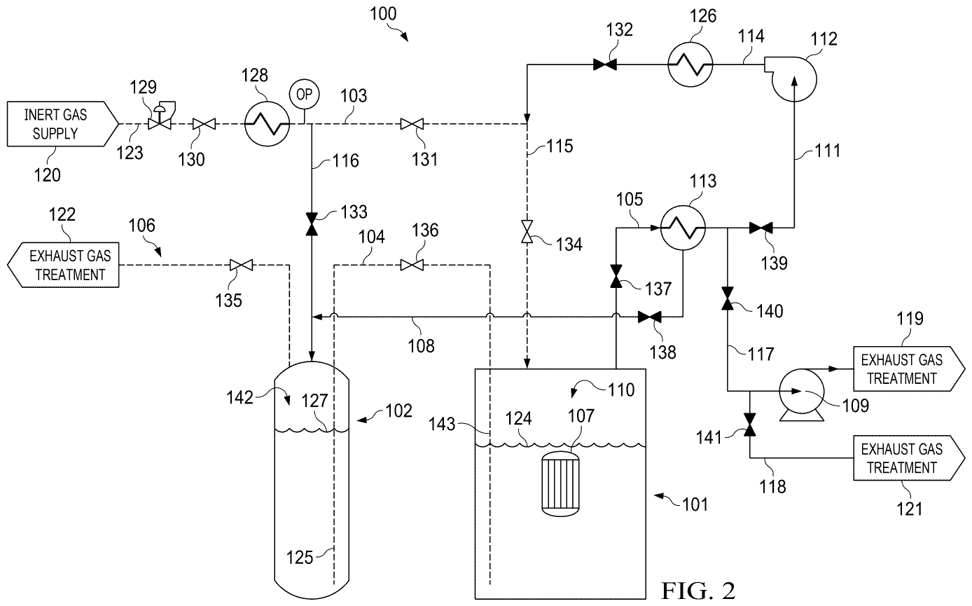

The first exemplary process in implementation of the present disclosure is shown in FIG. 2 and produces the transfer of LMC from primary vessel 101 to collection vessel 102 in liquid form. It is the preferred method of transfer for the bulk of the coolant because it is typically the fastest and requires the least amount of energy over the two evaporation methods to be described hereafter.

In this first exemplary process, the valves in system 100 are positioned as indicated in TABLE 1 in the vertical column designated for “Exemplary Process Number 1” (i.e., with valves 129-131 and 134-136 placed in the OPEN position and with valves 132, 133, and 137-141 placed in the CLOSED position; further, in FIG. 2, closed valves are depicted with dark fill, while conduit segments in which the flow occurs are indicated by dashed lines). With the valves thus positioned, pressurized gas from inert gas supply 120 is fed preferably through heater 128 (so as not to cool the LMC to where it might freeze) and from thence via gas/vapor conduits 103 and 115 into the headspace 110 of primary vessel 101, forcing LMC to leave primary vessel 101 via dip tube 143, through conduit 104 (and, as it is also hereinafter understood through open valves in conduits in which fluid is flowing, which in this case is open valve 136) to enter collection vessel 102, and venting the gases in the headspace 142 of the collection vessel 102 that are being displaced by liquid, said vented gases exiting system 100 via gas/vapor conduit 106 and exhaust 122. It is understood that since radioactive gases and/or particles exiting with the gas through any exhaust depicted in these descriptions, such as 119, 121 and 122, are subsequently filtered (e.g, with HEPA filtration) and/or sent through decay beds, as is readily understood by those skilled in the art. These transport conduits are typically constructed of seamless pipes, constructed of material compatible with the coolant, such as UNS S30400, or UNS S31600. These pathways may also be constructed of seamless tubing, or seamed pipe, similarly constructed of compatible materials known to persons skilled in the relevant art. To improve drainage of LMC, the core 107 of the reactor and components within primary vessel 101 are preferably designed with interior surface contouring that facilitate optimal evacuation of the LMC, e.g., they do not contain low spots or dished depressions that have no gravitationally-aided path for dropping to the low point of the vessel (preferably lowest point of liquid) near where the bottom end of the dip tube 143 is preferentially located. Preferably this low point may comprise a cupped end-cap or other localized depression (not shown) welded in place near the bottom-most end of the dip tube 143 to facilitate more complete drainage of LMC during this step.

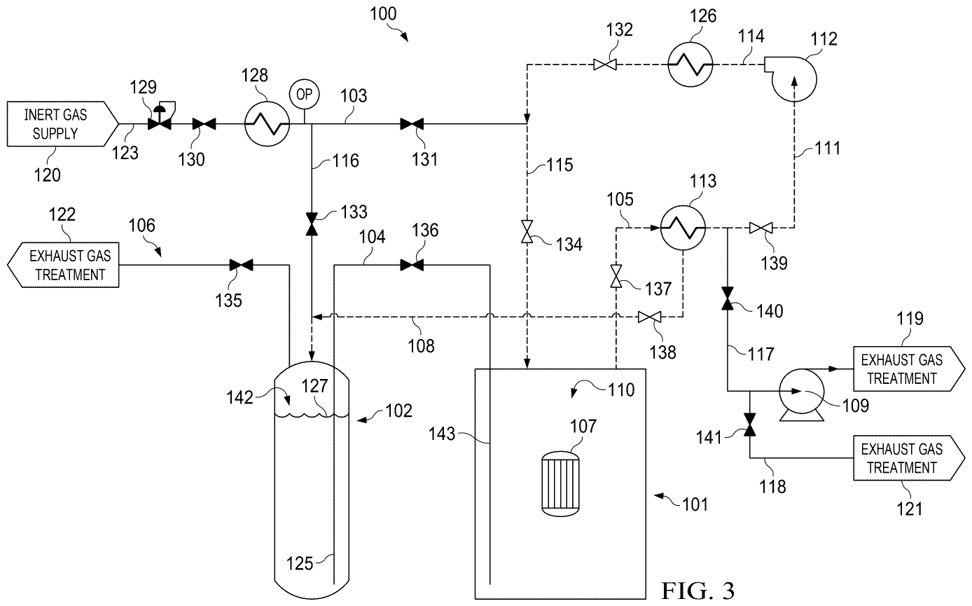

With preferably the majority of the LMC removed in liquid phase, the second exemplary process in implementation of the present disclosure is shown in FIG. 3, wherein the valves in system 100 are positioned as indicated in TABLE 1 in the vertical column designated for “Exemplary Process Number 2.” With the valves in this position, this second exemplary process produces evaporation of LMC residues from fuel rods and nuclear reactor components using forced convection. This is a preferred method of evaporation while the fuel decay heat is still high, as the forced gas flow both quickly evaporates LMC residues from fuel rods and components; it can also provide convective cooling of the reactor core (in order to accomplish, the temperature of the forced gas is high enough to produce the desired evaporation yet low enough to pull heat away from core assemblies). In this second exemplary process, gas and LMC vapor are drawn from primary vessel 101 via gas/vapor conduit 105, through cooled condenser 113 where LMC vapor is condensed to liquid phase and drains via liquid conduit 108, preferably under the influence of gravity, into collection vessel 102. The stripped gas leaving condenser 113 continues via gas/vapor conduit 111 and into the inlet of blower 112 through gas/vapor conduit 114 and re-heater 126 via gas/vapor conduit 115 back to primary vessel 101; here, it is preferably piped with conduits (not shown) directly to the core to provide cooling of fuel rods that are generating heat via nuclear decay and to provide convective drying of fuel rods, and also piped as needed to provide convective drying to the internals of components. In this configuration, the gas preferably circulates in a closed loop, which economizes the use of the inert gas supply and reduces the energy that would otherwise be expended to raise supply gas from ambient temperature to the elevated temperatures required to evaporate the LMC. From an evaporation rate standpoint, this is preferably performed at gas temperatures of from ˜500° C. to ˜880° C., for example when decay heat and/or available auxiliary heat is high, or less preferably at gas temperatures of from 200° C. to 500° C., for example when decay heat and/or auxiliary heat is lower. Operating pressure of this second exemplary process is preferably approximately atmospheric pressure.

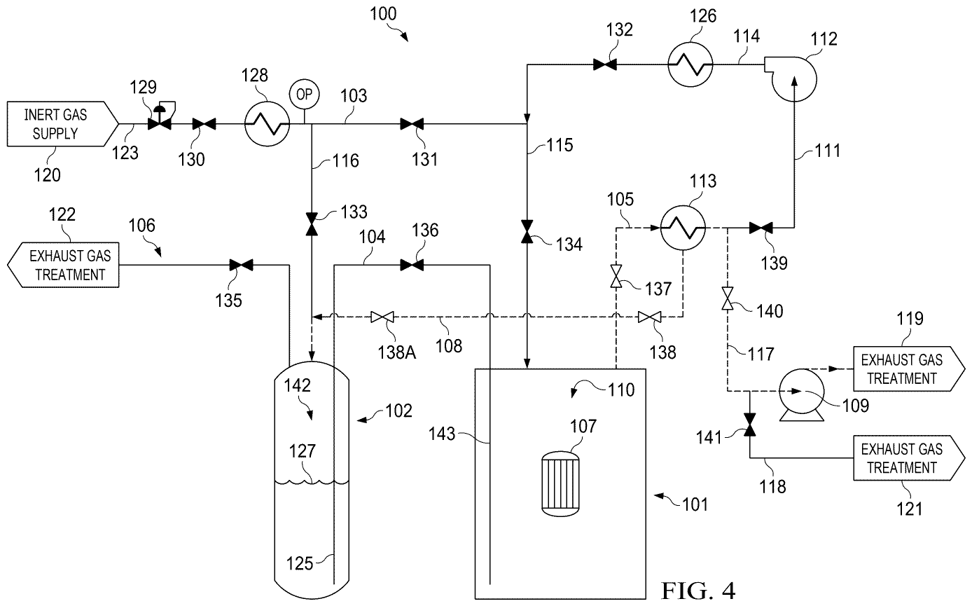

With preferably the majority of the bulk LMC removed in the liquid phase, and either in addition to, or in place of, the second exemplary process, the third exemplary process in implementation of the present disclosure is shown in FIG. 4. Here, the valves in system 100 are positioned as indicated in TABLE 1 in the vertical column designated for “Exemplary Process Number 3.” With the valves in position, this third exemplary process produces evaporation of LMC residues from fuel rods and reactor components using vacuum distillation. This is a preferred method of evaporation for the final drying stage, as it has been shown to be very effective at removing LMC residues from extremely tight spaces, for example even between mating nut and bolt threads. In this third exemplary process, vapor and/or gas is drawn from the headspace 110 of primary vessel 101 via gas/vapor conduit 105, through cooled condenser 113 where LMC vapor is condensed to liquid phase and drains via liquid conduit 108 into collection vessel 102. The stripped gas leaving condenser 113 continues via gas/vapor conduit 117 to vacuum pump 109 and is expelled via exhaust 119. Preferably, this process continues until condensate ceases to form and drain via liquid conduit 108 and the system pressure drops, both of which are indicative that the evaporation of LMC residue is substantially complete. In this second exemplary process, the system pressure preferably operates below ˜200 mTorr, and at temperatures of from ˜500° C. to ˜880° C., for example when decay heat and/or available auxiliary heat is high, or less preferably at temperatures of from 200° C. to 500° C., for example when decay heat and/or auxiliary heat is lower. Electric heaters, such as band or immersion heaters, may also be used to increase the temperature within vessel 101. The collection vessel 102 is maintained near the melting point of sodium to encourage condensation within the vessel 102, e.g., 120° C.-150° C.

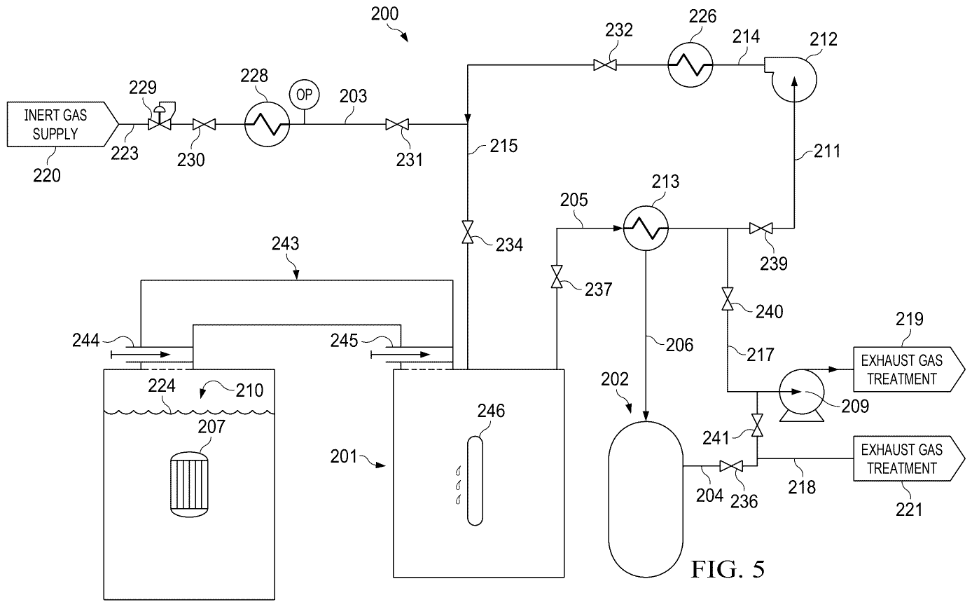

With both the majority of the bulk LMC and LMC residue removed from the fuel rods and components and interior surfaces of primary vessel 101, the fourth exemplary process in implementation of the present disclosure is to move fuel and/or components and/or perform maintenance. This is done by opening a gate valve in a flange or penetration (not shown, but similar to and substantially for the same purpose to gate valve 244 in FIG. 5) of primary vessel 101 and opening the vessel to ambient air, under radiation protection controls as is common in the art, and performing handling and/or maintenance operations with the relative ease and convenience that occurs when LMC is not present, not posing chemical reactivity hazards, and not blocking, with its opaqueness, the view of submerged items of interest.

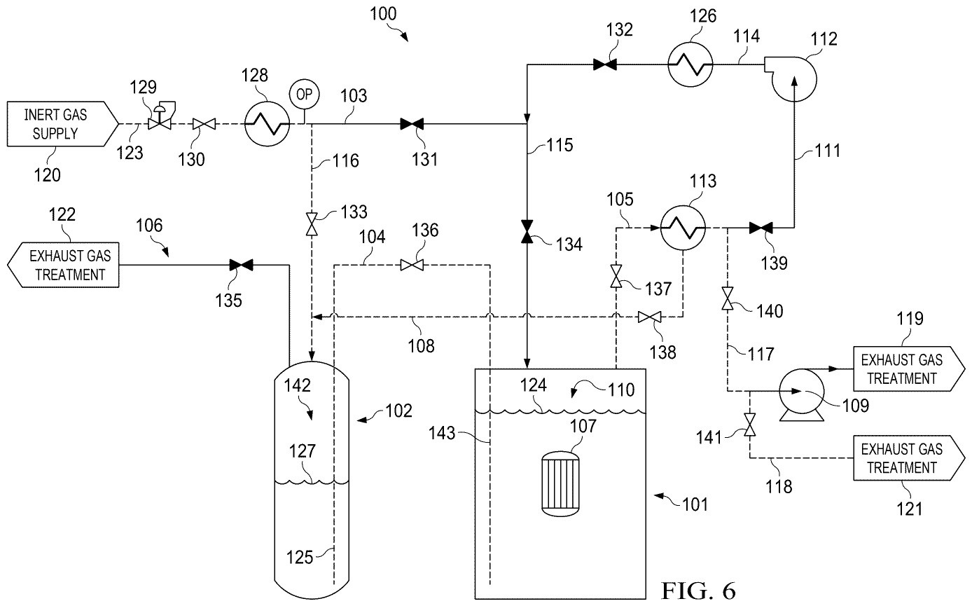

The fifth exemplary process in implementation of the present disclosure is shown in FIG. 6. Here, the valves in system 100 are positioned as indicated in TABLE 1 in the vertical column designated for “Exemplary Process Number 5.” With the valves in position, this fifth exemplary process produces the return of the bulk of the LMC from the collection vessel 102 to the primary vessel 101. This is accomplished by feeding inert gas from inert gas supply 120 via gas/vapor conduit 123 and heater 128. The headed gas then flows via conduit 116 into the headspace 142 of collection vessel 102. The pressurization pushes the LMC via dip tube 125 and liquid conduit 104 into primary vessel 101. With the gas and vapor in the headspace 110 displaced, it leaves via the gas/vapor conduit 105. The gas and vapor then pass through the cooled condenser 113 where LMC vapor is condensed to liquid phase and drains via liquid conduit 108 into collection vessel 102. The stripped gas leaving the condenser 113 continues via gas/vapor conduits 117 and 118 and is expelled via exhaust 121. In this way, coolant is re-used, saving costs in both replenishment and treatment.

For the evaporative and drying processes, and with reference to FIG. 1, the system 100 can be utilized in an exemplary process in an alternative implementation of the present disclosure. Following bulk transfer of sodium to the sodium storage tank 102, the inert gas supplied from line 103 is preferably heated to greater than 500° C. The heated gas is then sent through the conduit 115 and primary vessel 101 to facilitate coolant. The coolant is then evaporated by gas and transferred via line 104 from vessel 101 to the storage tank 102 and condensed. The storage tank is maintained at a cooler temperature, preferably ˜150-200° C., or more preferably ˜120-160° C. Inert gas is exhausted from the system via line 106, which routes the inert gas to an exhaust gas treatment. In this alternative implementation, the flow rate, and therefore evaporation rate, is slower than in a convective drying process, e.g., as detailed in the second exemplary process. However, it also can be performed without blower, pump, or condenser, and is therefore preferred when these latter items are relatively disadvantageous.

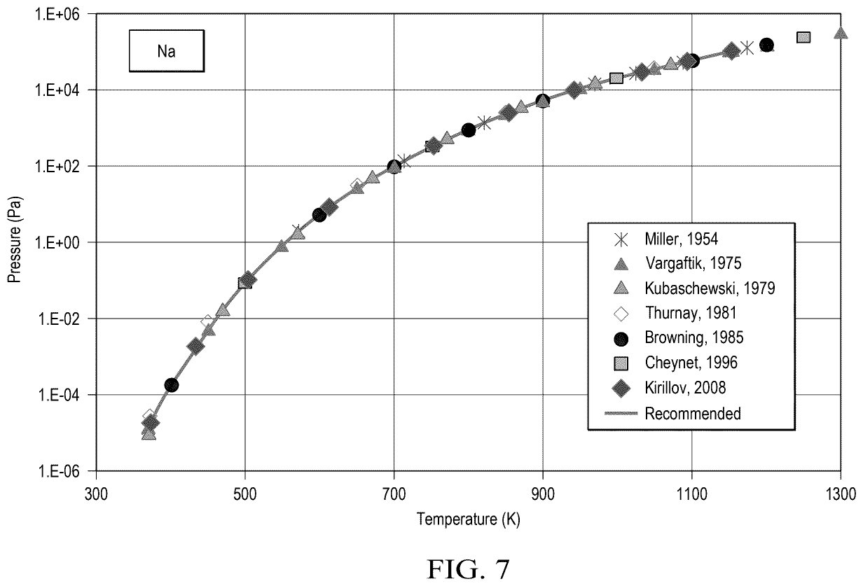

For the embodiment where liquid sodium is the liquid metal coolant, the preferred materials of construction for various subcomponents include 316 stainless steel pipe per ASME B31.3; 316 stainless steel tubes for conduits with modular, dis-assemblable 316 Swagelok VCR® fittings; 304 stainless steel flanges with copper gaskets for pipe conduit connections; aluminum O-rings for fittings in vacuum service. Connections are preferably ASME Section IX welding, and vessels are constructed under ASME Section III/Div I/III. Valves in piping are preferably bellows-type valves, e.g., Conval single-bellows seal valve, class 1500 STD, and forged stainless steel. Heat exchanger 113 is strategically located prior to the inlets of pump 109 and blower 112 to promote condensation of coolant vapors entrained in the gas; this not only contributes to the redistribution of liquid coolant (LMC for all embodiments generally, as well as specifically for liquid sodium for the embodiment thereof) from the internal volume of system 100 to the collection vessel 102, but also in part serves to protect the equipment and mitigate damage from exposure to the coolant. To effectively remove coolant vapors, heat exchanger 113 preferably operates closer to the freezing point of the coolant (which for sodium is ˜97.8° C.), but not so close as to run the risk of freezing within the equipment; this typically condenses vapors to a liquid in the temperature range of (when sodium is the coolant) 150-200° C., but more preferably in the lower temperature range of, for example, 120-160° C. As shown in the FIG. 7 graph, the vapor pressure of sodium at 120 or 150° C. (˜393 or ˜423K, respectively) is many orders of magnitude lower than the vapor pressure of sodium at for example 550° C. (˜823K), the latter being closer to the approximate temperature of coolant in primary vessel 100 after reactor shutdown. The convection drying rate and vacuum distillation rates are roughly proportional to difference in vapor pressure between the liquid coolant at the surface to be dried in primary vessel 100 and the partial pressure of the vapor of the coolant in the gas within headspace 110. Likewise, the condensation rate is roughly proportional to the difference in vapor pressure between the vapor pressure of the coolant in the gas in condenser 113 and the vapor pressure of coolant of the liquid in condenser 113. Therefore, the coolant is readily evaporated within primary vessel 100 at the higher temperature and readily condensed in condenser 113 at the lower temperature, effectively benefiting both speed of the process and protection of downstream blower 112 and pump 109. The current embodiment vacuum pump 109 removes mostly inert gas from within the system 100 to reduce the pressure below atmospheric pressure such as screw, turbomolecular, or others typical in the art of reducing pressure within confined systems. Blower 112 that is used to circulate the inert gas (such as argon) may take the form of a scroll or rotary pump, but in a preferred embodiment, is a pressure blower supplied by Chicago Blower. Vacuum pump 109 is preferably a dry pump (e.g., oil-less) so that foreign material does not volatilize, contact, and react with the LMC vapor. Such a pump 109 could comprise, for example, a Leybold Scrollvac. In an alternative second exemplary process sequence embodiment, the outflow of blower 112 in FIG. 3 is directed via an exhaust gas treatment outlet (using additional valves and conduit, not shown); this speeds up the bulk removal of inert gas from primary vessel 101, and also allows a smaller vacuum pump 109 to be utilized for the third exemplary process. Therefore, this alternative second exemplary process sequence embodiment can save pump-down time and cost. Pump 109 and blower 112 should be constructed of materials compatible with the coolant as previously described and will be readily apparent to those skilled in the art.

Collection of the reactive opaque coolant is achieved by collection vessel 102. Collection vessel 102 is constructed of materials compatible with the coolant, typically UNS S30400 or UNS S31600. Collection vessel 102 may also be constructed from other materials deemed compatible with the coolant, such as austenitic stainless steels, ferritic stainless steels, or nickel alloys. Further, collection vessel 102 is suitably designed and constructed for the conditions required for the process to be performed, such as pressures below and above atmospheric pressure, and elevated temperatures >500° C., as is readily accomplished by one skilled in the art. Additionally, the collection vessel 102 may be mobile, permanently located, or part of another system for further coolant operations, such as purification, analysis, or inspection.

Cooling for controlled condensation of the coolant is performed in this embodiment by heat exchanger 110 or 113 if in vacuum or convective evaporation modes, respectively. The heat exchangers may take the form of liquid cooled (including liquid metal cooled), gas cooled, or other heat exchanger, including technologies such as printed circuit heat exchangers, plate heat exchangers, or shell and tube heat exchangers. Alternative configurations may include direct cooling of the collection vessel 102 via the use of liquid or gas heat exchange across the exterior surface of the vessel. The vessel 102 may also optionally include fins on its exterior surface to promote greater cooling.

In another embodiment of the current disclosure, FIG. 5 shows a schematic depicting storage system 200 comprising reactor vessel 255; storage and evaporation vessel 201; collection vessel 202; fluid conduits 223, 203-205, 208, 211, 214, 215, 217, 218, 223; vacuum pump 212; heat exchangers 213 and 226; reactor vessel 255 comprising LMC with surface level 224, headspace 210 with gas and vapor, reactor core 207 comprising fuel rods and/or fuel assemblies; inert gas supply 220 with pressure regulator 229; gate valves 244 and 245; component/fuel passageway 243; and valves 230-232, 234, 236, 237, 240, and 241. With this configuration, fuel and/or components may be removed from reactor vessel 255 wetted with LMC and transferred using lifting and manipulating equipment (not shown) as is known in the art through opened gate valve 244 and via pathway 243, through gate valve 245, and into storage vessel 201. This embodiment further comprises processes similar to the second exemplary process of forced convection (including in a closed loop configuration) for the purpose of cooling and/or drying the component and/or fuel. It also includes processes like the third exemplary process of vacuum distillation for the purpose of drying the component and/or fuel. This embodiment is also beneficial because it provides cooling and/or drying of components ex-situ to reactor vessel 255 while the reactor is still in use; it reduces the need for further wash equipment and facilities, as well as an associated waste stream.

The above descriptions make it clear that many activities in the operation of a LMC-cooled reactor benefit from use of the present disclosure: maintenance activities; refueling; and repair of, including, but not limited to, components and equipment with significant improvement over the current art approaches of in-vessel operation of the activities, resulting in less complex equipment, reduced requirement for pre-heating, and smaller vessels to accommodate these activities.

TABLE 1
Valve configurations of exemplary processes.

| Valve | Exemplary Process Number -> | | | | |
|---|---|---|---|---|---|
| Number | 1 | 2 | 3 | 4 | 5 |
| \/ | Position | Position | Position | Position | Position |
| 129 | OPEN | CLOSED | CLOSED | CLOSED | OPEN |
| 130 | OPEN | CLOSED | CLOSED | CLOSED | OPEN |
| 131 | OPEN | CLOSED | CLOSED | CLOSED | CLOSED |
| 132 | CLOSED | OPEN | CLOSED | CLOSED | CLOSED |
| 133 | CLOSED | CLOSED | CLOSED | CLOSED | OPEN |
| 134 | OPEN | OPEN | CLOSED | CLOSED | CLOSED |
| 135 | OPEN | CLOSED | CLOSED | CLOSED | CLOSED |
| 136 | OPEN | CLOSED | CLOSED | CLOSED | OPEN |
| 137 | CLOSED | OPEN | OPEN | CLOSED | OPEN |
| 138 | CLOSED | OPEN | OPEN | CLOSED | OPEN |
| 139 | CLOSED | OPEN | CLOSED | CLOSED | CLOSED |
| 140 | CLOSED | CLOSED | OPEN | CLOSED | OPEN |
| 141 | CLOSED | CLOSED | CLOSED | CLOSED | OPEN |

What is claimed is:

1. An apparatus comprising:
a main vessel containing the component and coolant;
a coolant movement/displacement mechanism;
a heating mechanism for coolant evaporation;
a transport pathway for coolant vapors;
a vacuum means or gas circulation means;
a cooling and collection mechanism for condensation of coolant vapors; and
a collection vessel for storage of moved/displaced fluid.

2. The apparatus as in claim 1 further comprising the evaporation chamber, the condensation means, the collection vessel, and the selectable liquid return means within a closed loop.

3. The apparatus as in claim 1 further utilizing fuel decay heat to provide heat for evaporative removal.

4. The apparatus as in claim 1 wherein the heating mechanism comprises heated inert gases and forced or natural convective evaporation.

5. The apparatus as in claim 1 further comprising utilizing vacuum distillation.

6. The apparatus as in claim 1 further comprising an additional handling mechanism for removing fuel or a component from the main vessel and transporting it to a second radiological confinement (for activated debris and failed fuel debris, and for fission product gases).

7. The apparatus as in claim 1 further comprising a coolant flow removal mechanism in addition to evaporative removal.

8. The apparatus as in claim 1 wherein the main vessel also encloses a reactor core during reactor operation.

9. The apparatus as in claim 1 wherein the main vessel is used for receiving and storage of coolant-wetted core components soon after their removal from a reactor as they are allowed to cool and shed decay heat.

10. A method comprising:
moving a bulk of a coolant fluid to a collection vessel;
evaporating liquid coolant residues;
transporting evaporated vapors to a condensation means for reduction to liquid and collection in a collection vessel;
opening a main vessel; and
handling fuel or other components in the main vessel.

11. The method as in claim 10 further comprising the evaporation chamber, the condensation means, the collection vessel, and the selectable liquid return means within a closed loop.

12. The method as in claim 10 further utilizing fuel decay heat to provide heat for evaporative removal.

13. The method as in claim 10 wherein the heating mechanism comprises heated inert gases and forced or natural convective evaporation.

14. The method as in claim 10 further comprising utilizing vacuum distillation.

15. The method as in claim 10 further comprising additional handling means for removing fuel or a component from the main vessel and transporting it to a second radiological confinement (for activated debris and failed fuel debris, and for fission product gases).

16. The method as in claim 10 further comprising coolant flow removal means in addition to evaporative removal (for the case where this step might be a dependent claim rather than part of the independent claim).

17. The method as in claim 10 wherein the main vessel also encloses the reactor core during reactor operation.

18. The method as in claim 10 wherein the main vessel is used for receiving and storage of coolant-wetted core components soon after their removal from the reactor as they are allowed to cool and shed decay heat.
